(19) United States
(12) Patent Application Publication
(10) Pub. No.: US 2008/0003984 A1
(43) Pub. Date: Jan. 3, 2008

(54) Method and system for improved handling of message templates

(76) Inventors: Christian Kraft, Frederiksberg (DE); Peter Dam Nielsen, Lyngby (DE); Yan Dong Wen, Beijing (CN); Da Xing, Beijing (CN)

Correspondence Address: PERMAN & GREEN, 425 POST ROAD, FAIRFIELD, CT, 06824, US

(21) Appl. No.: 11/478,323

(22) Filed: Jun. 29, 2006

(51) Int. Cl. H04L 12/58

(52) U.S. Cl. 455/412.1

(57) ABSTRACT

A method for providing efficient handling of messages in a mobile communication terminal comprising associating at least one message template with at least one recipient. The template comprises at least a first recipient identifier and at least a first sequence of predetermined symbols. A method for retrieval of a message template from a group of candidate message templates, a communication terminal, a server and a computer program for implementation of the methods.

### FIELD

The aspects of invention relate to improved handling of messages, especially methods for creating an association of a message template with a recipient and retrieval of such a message template. The disclosed embodiments also relate to a communication terminal in which the invention is implemented and a computer program adapted to perform the steps of the aforementioned methods.

### BACKGROUND

People like to communicate and the connected society of today helps people to stay in touch. However, rather than always communicating to each other directly, for instance over a telephone, sending messages may in many circumstances be more convenient.

The number of messages sent across the world is greatly increasing. People continue to find more and more reasons to send each other messages. Sometimes we want to make an appointment, sometimes we send a reminder to someone and sometimes we just want to tell something.

Studies have shown that many users tend to send almost the same text messages to some persons, e.g. “I love you” or “thinking of you”. Other trends point to that many users use the same ending for messages being sent to specific persons, e.g. “BR Christian” to official contacts, “Cheers, Christian” to friends, “Kisses, Christian” to spouse etc.

Also, reducing cost is a key issue for many users when sending short messages. Studies, such as “Core Mobile Areas Based on Usage Studies, End User Feedback and Competitor Product Analysis—Version 2.2” by Johanna Vuorio, Fumiko Ichikawa and Kaisa Savolainen (October 2005), have shown that users to a large extent try to fit their text into a single message. For instance, many users try to fill up their text to fit one message fully. In other words, users want to get the most value possible for the money. The same holds for concatenated messages such as those of a length corresponding to two or three single messages.

Furthermore, composing and sending service provider based messages, such as to access certain services or to interact with program hosts provided by for instance radio channels, TV stations, operators and service providers have become increasingly popular. In this connection, the typical approach is that customers send an SMS having a certain format to a certain number. For instance, a customer may send “Weather”+area code to a service number to get the local weather forecast. Currently, mobile phones only support storing of phone numbers. Therefore, in order to send an interactive SMS, users have to enter the SMS texts manually. Also, they have to keep all the formats in their head. When users frequently use some services everyday, it will be awkward to enter the same number and texts everytime.

Additionally, in current mobile devices, a user cannot save messages for repeated subsequent retrieval for composing and sending additional, identical or similar messages.

According to one existing way of dealing with frequently used phrases, communication terminals are sometimes preloaded with message templates comprising common phrases. However, for various reasons, such as being too general and non-editable, these templates poorly meet current and future demands of flexibility and individuality with its limited functionality. Hence, it is a task to develop a more intuitive, intelligent template, and use of the same, for fulfilling the needs of the connected common man and to enable a range of new uses and applications.

Hence, as the popularity for sending messages grows, an effective solution should be provided in mobile phones. It is asked for an improved way of organizing messages and render them more ready to use for an end user.

### SUMMARY

The aspects of the invention relate to an intelligent SMS/MMS template for improved message composing in communication devices, such as communication terminals. The intelligent template is advantageous both for use when composing private messages as well as when composing messages intended for a service provider system, such as recognized by a server. Although the embodiments are described especially with regards to implementation in a communication terminal it is also within the scope of the invention to implement an intelligent template according to the invention in an e-mail client of for instance a personal computer, handheld organizer or the like.

According to a first aspect of the invention, a method for providing efficient handling of messages in a mobile communication terminal comprises associating at least one message template with at least one recipient, the template comprising at least a first recipient identifier and at least a first sequence of predetermined symbols. Hereby, a number of message templates may be associated with each contact in for instance a list of contacts. By having the templates individually matched to each contact, high relevance of its content as to the recipient is ensured. As an advantage, composing similar messages is made more convenient. As a further advantage, message templates can be individualized and thereby increase usability of templates.

According to one embodiment, the association is performed upon a received user input. For instance, while composing a message, a user may retrieve a list of options and select an option for associating the message to a contact stored in the terminal. The template can also be associated in connection with sending the message, either by manually selecting an option available for this action, or automatically by the terminal. According to one embodiment, at least a part of a message is stored as a message template in connection with sending the message. Hence, no user interaction is required. The behaviour of the terminal in connection with automatic storing and association of message templates based on outgoing messages may be configured according to any user's personal preferences.

The outgoing message may be stored in its entirety, or for instance only the initial and ending paragraphs or sections of the message. Hereby, as an advantage, the most common openings or endings of a message may be automatically stored as a message template, and especially, be associated with a specific recipient.

A message template having been associated with a contact may be used to create a new message. The user can choose to send it immediately, or edit it before sending.

According to a further embodiment the recipient identifier may identify a service provider. Hence, a message template can be associated with a service of a service provider. The service provider may for instance be an operator of mobile services.

According to one embodiment the sequence of predetermined symbols is associated with a service provided by a service provider. As an advantage, information may be stored according to a specific format for a server of the service provider to interpret.

According to one embodiment, interactive message templates may be stored according to different categories such as sports, weather, financial, news, charity, TV shows, etc, making it easier to find a specific template, especially when the number of templates is high.

According to another embodiment, the method further comprises a step of removing, an association between a contact and a message template. Message templates no longer needed can then be removed, freeing up storage space in the terminal. For instance, an association may be removed by deleting or purging a message template. Alternatively, removal of a contact will remove any templates associated this contact. Removal of message templates can be performed by interaction from a user, for instance in connection with browsing through available templates. Removal of an association may also be performed automatically by the terminal on associations where a message template has not been used within a predetermined period of time. Furthermore, removal may be performed using a first-in-first-out principle. Memory storage can be reclaimed for the most recently added message templates. For instance, only a predetermined maximum number of message templates can be allowed simultaneously to be associated with each contact. Upon adding a new message template to a contact another template, for instance the oldest or least used, from a group of message templates associated with the contact is then removed.

Hence, a way of avoiding extreme memory usage without requiring user interaction is provided. Additionally, templates which have not been used within a predetermined period of time may also be erased automatically. Exceptions may apply to for instance manually entered messages templates or to templates specified not to be automatically be erased. Again, these embodiments helps keeping the memory load down in the terminal.

The above advantages and features together with numerous other advantages and features, which will become evident from below detailed description, can be obtained according to a second aspect of the invention by a method for retrieval of a message template from a group of candidate message templates comprising a step of presenting a first candidate message template from the group of message templates. The group of templates may be associated with a recipient. The wording candidate message template refers to a message template being selectable for use in a message.

Hence, in response to a user input for selecting a recipient from a contact list, a list of available candidate message templates associated with the contact may be presented. As an advantage, people are used to make selections from lists and presentation in a list creates a good overview over available templates.

According to one embodiment, convenient retrieval of a message template is enabled by activation of a group of available templates associated with a recipient. Upon activation, the available templates are presented to the user, for instance in the form of a list.

The activation may further involve receiving a user input through pressing and holding an activation key. According to a specific embodiment, the activation key is the star ‘*’ key. Hence, a user may press a key, hold it for a predetermined time interval, whereupon the group of templates is presented to the user, preferably on a suitable user interface such as the display of the communication terminal. As an advantage, an efficient and simple way of retrieving the group of available templates to choose from is provided.

According to one embodiment, the available group of templates is activated upon selection of recipient, for instance from a contact, list.

According to another embodiment, activation is performed while composing a message, for instance in response to a user input, such as by pressing a key for retrieval of available options followed by selection of an option for presenting the available templates. Alternatively, the activation involves matching of a pattern in a message with that of a candidate message template. According to a specific embodiment, the matching is performed upon composing a message. Hence, as an advantage, retrieval of a template through sentence completion is enabled, for instance while editing an outgoing message.

According to various embodiments of the invention, the matching may involve any of:

receiving a first sequence of symbols from the message;

identifying a corresponding sequence of symbols in at least a first candidate message template of the group of templates;

presenting the first candidate message template comprising the corresponding sequence of symbols;

receiving a user input for selection of the candidate message template; and

inserting the candidate message template into the message.

Additionally, the symbols may comprise characters and the pattern may comprise letters and/or words.

According to one embodiment, the activation comprises a combined match of both contact and pattern.

According to a further embodiment, the retrieval may involve any of:

receiving a user input through a candidate scroll key for scrolling through the candidate message template;

receiving a user input through a candidate cycle key for scrolling through the group of candidate message templates;

presenting a second candidate message template from the group of templates;

receiving a user input through a candidate accept key for accepting the candidate message template; and

inserting the candidate message template into a message.

The candidate scroll keys may for instance be used where a message template is too large to be presented in its entirety, depending on the size of the display on which the message template is presented. As an advantage, by using one or more candidate cycle keys instead of the scrolling keys or navigation keys for scrolling between templates, a user is enabled to use the scroll or navigation keys for scrolling within a template. According to specific embodiments, the candidate scroll keys are any of the ‘up/down/left/right’, ‘left/right’, or ‘up/down’ keys.

The candidate cycle key may for instance be used for scrolling up or down between different available template candidates. According to specific embodiments, the candidate cycle key is any of the star ‘*’ or cross ‘#’ symbols, ‘up/down’ arrows, or ‘left/right’ arrows.

The candidate accept key may for instance be used for accepting, or selecting a candidate template for use as a message or in a message. According to specific embodiments, the candidate accept key is any of ‘space’, ‘right/space’, joystick middle, or a softkey.

According to one embodiment, the candidate cycle key is the star symbol ‘*’, the candidate accept key is ‘space’, and the keys for scrolling within template are ‘up/down/left/right’.

According to another embodiment, the candidate cycle keys are ‘up/down’, and candidate cycle key is ‘#’ and the candidate scroll key is ‘space’.

According to a further embodiment, the candidate cycle key is ‘*’ and the candidate accept key is ‘0’ and/or ‘space’.

Alternatively to using candidate cycle keys to go through available message templates, the templates may also be presented automatically after each other for a given time interval. In this way, the user may conveniently view the alternatives automatically presented after each other, and when a preferred template is presented, the user may press a button associated with a predetermined action to select it.

According to one embodiment, the key that is used for scrolling through candidate messages is the same key that is used for retrieving the available candidate messages. Hence, a single key is associated with dual functions or actions. By pressing and holding the key for a short while, a first candidate message among available message templates is presented. Upon another, shorter, press of the key, a second message from the available message templates is presented. By repeatedly pressing the key briefly, the user may scroll through available message templates. As an advantage, a single key may be used to receive different input, such as both for retrieving a group of templates and to scroll through available templates. Hence, by holding and pressing the key, available templates are presented. Then by repeatedly pressing shortly, a user may scroll through the available templates. According to a further embodiment, by holding and pressing the key again, a template is accepted and the user returns to the task working with initially, for instance composing a message in which the message template is incorporated. According to an alternative embodiment, by holding and pressing the key while scrolling through available templates, the user returns without accepting any message template. According to one embodiment of the present invention, the message template is any of an SMS, MMS, or e-mail.

The above advantages and features together with numerous other advantages and features, which will become evident from below detailed description, are obtained according to a third aspect of the invention by a communication terminal adapted for providing efficient handling of messages, the terminal comprising means for associating at least one message template with at least one recipient, the template comprising at least a first recipient identifier and at least a first sequence of predetermined symbols.

The above advantages and features together with numerous other advantages and features, which will become evident from below detailed description, are obtained according to a fourth aspect of the invention by a system a server and a communication terminal. The server is arranged to provide the communication terminal with a message template associated with a recipient. The message template may be an interactive system message template for interpretation by the server in connection with requesting a service provided by a service provider. The provision may involve retrieval with the communication terminal of said message template from the server, and the retrieval may involve a request from the communication terminal to the server. The retrieval may further involve a query of a number of a service provided by a service provider.

Hence, message templates may be downloaded as such, both on request although also upon query of a number not yet being associated with any message templates.

As an advantage, service providers may hence provide service subscribers with message templates being associated with a service number. It is for instance advantageous in that it does not require any interaction from the user to facilitate the association. The user may for instance accept an incoming message template to be stored together with the service provider ID in the list of contacts.

The above advantages and features together with numerous other advantages and features, which will become evident from below detailed description, are obtained according to a fifth aspect of the invention by a computer program for performing any of the methods as describe above.

In one embodiment, a recipient may be retrieved from a list of contacts associated with received messages, or a contact list over contacts in for instance a phone book.

According to a specific interpretation of a message template, it involves a recipient specific message template.

### BRIEF DESCRIPTION OF THE DRAWINGS

The above, features and advantages of the invention, will be better understood through the following illustrative and non-limiting detailed description of preferred embodiments of the present invention, with reference to the appended drawing, wherein:

FIG. 1 shows schematically a block diagram of a mobile communication terminal according to one embodiment of the invention;

FIG. 2 shows a schematic diagram of the steps in a method according to one embodiment of the invention;

FIG. 3 shows a schematic appearance of a user interface during use according to one embodiment of the invention involving retrieval of a template using sentence completion;

FIG. 4 shows a schematic appearance of a user interface during use according to one embodiment of the invention involving retrieval of a template using a list;

FIG. 5 shows a flow chart according to one embodiment of the invention where a message template is retrieved following a selection of recipient;

FIG. 6 shows a flow chart according to one embodiment of the invention where a recipient is retrieved following a selection of message template;

FIG. 7 shows a schematic appearance of a user interface during use according to one embodiment of the invention;

### DETAILED DESCRIPTION OF PREFERRED EMBODIMENTS

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the invention.

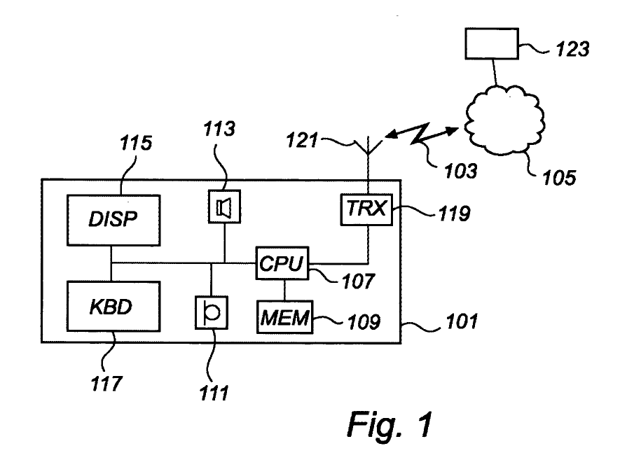

FIG. 1 illustrates schematically a communication terminal 101 in which the aspects of the invention can be implemented. The terminal 101 is capable of communication via an air interface 103 with a radio communication network 105 such as the well known systems CDMA2000, D-AMPS, GSM, UMTS, EDGE, etc. The terminal comprises a processor 107, memory 109 as well as input/output units in the form of a microphone 111, a speaker 113, a display 115 and a keyboard 117. Radio communication is realized by radio circuitry 119 and an antenna 121. Connected to the radio communication network 105 is a controller 123. The details regarding how these units communicate are known to the person skilled in the art and is therefore not discussed further.

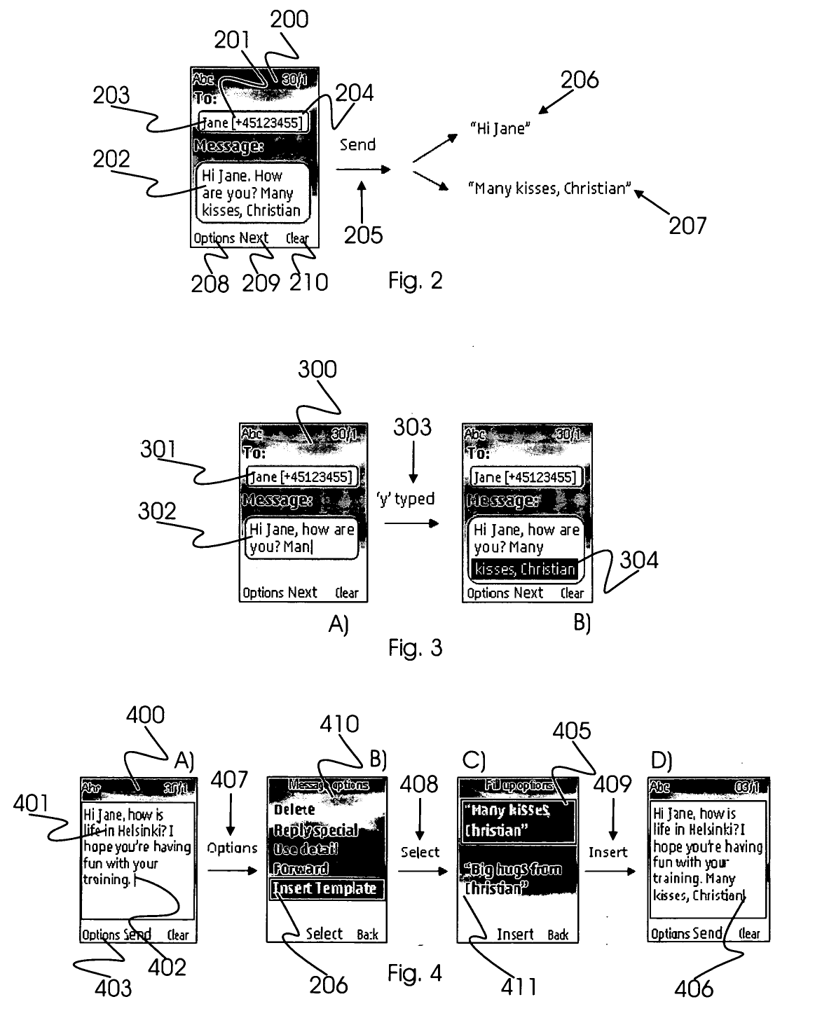

FIGS. 2, 3, 4, and 7 illustrates the appearance of a user interface during use according to various embodiments of the invention. Screenshots are shown together with schematically illustrated user actions. Furthermore, the actions referred to are generally effected by keypad, or touch sensitive display, input. Especially, certain actions have associated soft-keys indicated by for instance reference numerals 208, 209, 210, 403, 705, 708 and 709.

FIG. 2 shows how one way of associating a contact specific template with a specific contact is performed. The figure illustrates a draft message 200 having a recipient 201 and a text body 202. The recipient is indicated by a name 203, which can also be a nickname, and a telephone number 204. When the message is sent, as illustrated by the action “send” 205, parts 206 and 207 of the text body, or even the entire text body, is stored in a memory in the mobile telephone. These parts are then available for use when composing a message, as will be discussed in the following.

Turning now to FIG. 3, an example is shown where a user after having sent a message as described in connection with FIG. 2 composes a new message 300 to the same contact 301 shown in section a) of FIG. 3. Here, the user has selected the recipient 301 and begun composing the text body 302 of the message 300. When the letter “y” is typed, as indicated by action 303, software in the terminal recognizes the phrase “Many” as a part of a previously stored contact specific template associated with the contact and presents a suggested continuation of the phrase 304, namely “kisses, Christian” as shown in section b) of FIG. 3. The user may select this completion by pressing a key, soft key or touch key set for this purpose. It is also possible that the phrase is recognized at a different position, for instance earlier when typing “n” in “Many” or later when typing “k” in “kisses”. Further, if there are more than one phrase or template found to match the typed phrase, the user may select a preferred completion from a list, such as from a pop-up window.

Alternatively, a user may also manually select a contact specific template when composing a message as illustrated in FIG. 4, sections a) to d). At a given position 402 in the text body 401 of the message 400, the user presses the options soft-key 403, illustrated by the action “options” 407. From an options list 410, the user selects “insert template” 404, illustrated by the action “select” 408. The user is then presented with a list of templates 411 to choose from, selects the template “Many kisses, Christian” 405, illustrated by the action “insert” 409, whereby the phrase 406 is inserted into the text body 401 of the message 400. The details of the procedure may vary, but the essence of it is to easily access a contact specific template among one or more such templates previously associated with a contact chosen as a recipient of a message. From a user's point of view, this is a lot more convenient as compared to pre-stored, generic templates which are non-personified and often complicated to access.

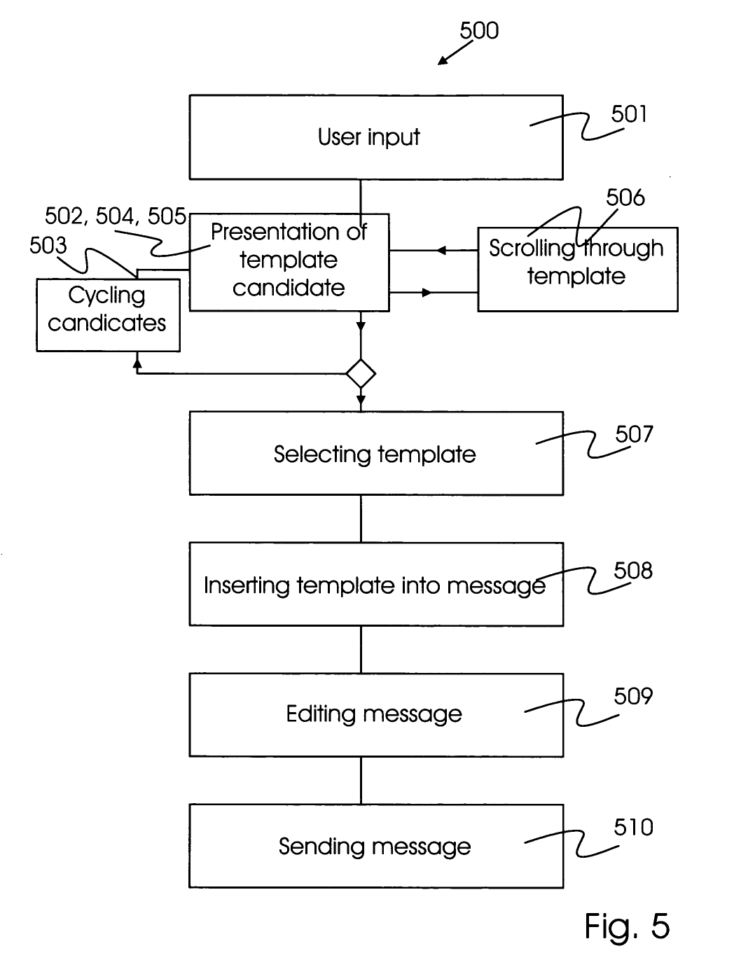

FIG. 5 shows a flow chart of steps comprised in the method 500 for retrieval of a message template among a group of candidate templates according to the present invention. The communication terminal receives, in a reception step 501, an input from a user indicating selection of a contact as recipient of a message. The terminal presents, in a presentation step 502, a first candidate template associated with the selected recipient. Further candidate templates from the group of available templates can be presented, indicated by steps 504 and 505 by receiving additional input from the user in cycle step 503. In the case a candidate template is trunkated and not displayed in its full length, perhaps due to limited screen size, the terminal may receive input for scrolling through the message template, indicated by scrolling step 506. When the user has found a preferred template, he makes his selection by providing an input to the terminal 507, whereupon the template is inserted 508 into the body of the message. The user may continue to edit the message 509 before sending it 510.

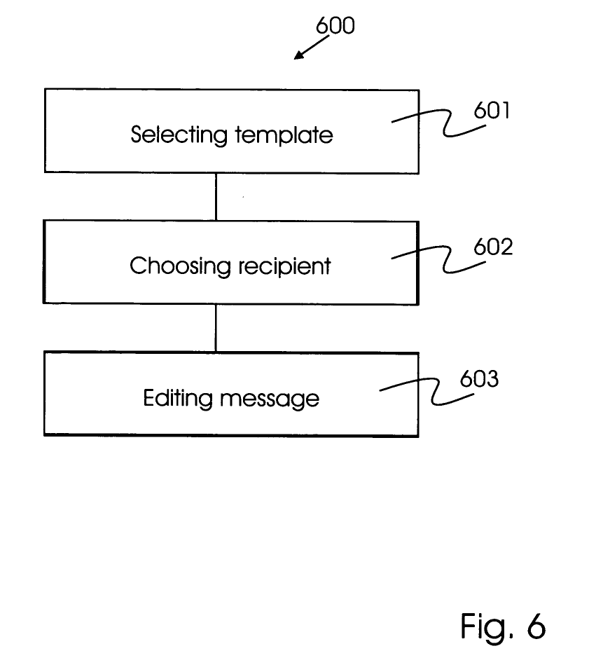

Alternatively, as shown in a flow chart 600 in FIG. 6, a template is selected 601, and from a number of contacts which are associated with the template, one recipient is chosen 602. Also here, the user can edit the message before sending it 603.

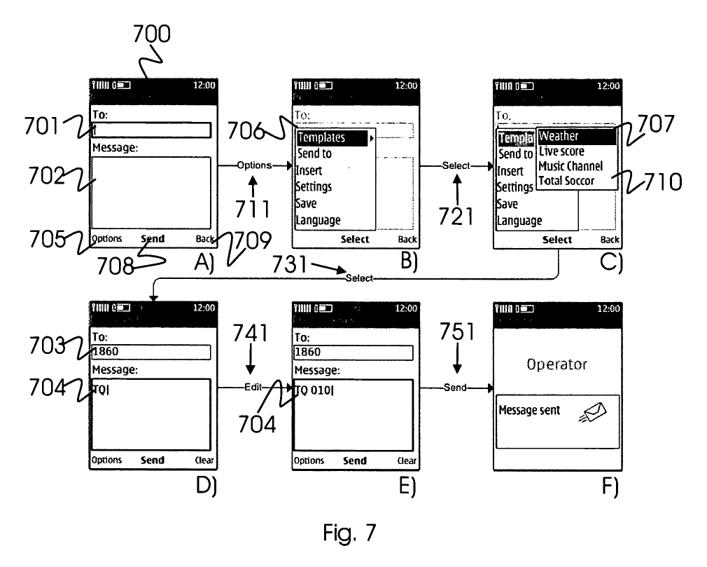

FIG. 7 illustrates the appearance of a user interface during use according to an embodiment of the invention in which a template is associated with a service number of a service or content provider. The sequence of steps are indicated by sections a) to f) of FIG. 7. The figures illustrates a draft message 700 having a recipient field 701 and a message body 702. The recipient is indicated by a service number 703 and the message comprises a sequence of symbols, or characters 704 associated with a service of a service provider (not shown), and which symbols are recognized and interpreted by a server (not shown). Also illustrated in the figure are soft-keys for retrieving an options list 705, sending a message 708 and leaving the message editing environment 709. For instance, in section a) of FIG. 7 an interactive SMS is created and an options menu list is retrieved, illustrated by action “options” 720. An option “templates” 706 is selected, illustrated by the action “selected” 721. A list of candidate templates 710 available to choose from is presented as shown in section c). From the list 710, a template 707 associated with a weather service is selected, illustrated by action “select” 731. The service number of the service 703 and a sequence of symbols 704 appears in the recipient field and text body respectively as shown in section d). The message may be edited, as illustrated by action “edit” 741, before transmission as for instance indicated in section e), wherein “Q10” has been added to the text body, perhaps indicating the area of desired weather forecast. The message is sent, illustrated by action “send”, to the recipient as shown in section f), which in this case is a weather forecast service provided by a service provider. In response, the recipient receives a message from the service provider stating the weather forecast as ordered. Advantageously, this procedure can be repeated any number of times, and also, the template may be edited to also comprise, as in this example, the given area indicator. Hence, the number of steps needed for a user in order to retrieve weather information is reduced. For instance, a user may only need to select a template associated with a service and send it. According to one implementation, only one step is needed for a user to send a predetermined message template associated with a recipient. For instance, pressing and holding a predetermined key may be interpreted by the terminal as a request to instantly send a specific template to a specific recipient.

In addition to the conventional contact fields of a contact identifier, such as a name or nickname, and a service number or phone number, it is within the scope of the invention to further have a contact field for the message type. Hence, it enables a descriptive naming for each individual message associated with a contact, such as “Tram” for ordering tram tickets.

As an example, a message can comprise the following information.

To: 17625

Message: Tram Adult

With the message type field, the message can for instance be named “Tram ticket”. The message type field can also be used to distinguish different services provided by a service provider, for instance “Tram ticket”, “Tram Family ticket” etc. It is then easier for a user to find the right message for a certain service. Message type of contacts are presented in the same way as conventional contacts, although they can be marked in some way to differentiate message type of contacts from conventional contacts.

A contact list could look like this:

. . .

Teemu Mäkinen

Tram ticket

Trevor Linden

Trine

. . .

A message type of contact can also be implemented to comprise multiple recipients. It is for instance useful when a user sends a message regularly to multiple persons. Examples include reminders to people about recurring events such as sports or music practices, gaming events, meetings etc. A message can then be sent to a group of people with the same text, for instance: “Remember Ultimate today!”. The contact could be called “Ultimate reminder” in the contact list. Upon selecting this message type of contact, it could be sent within seconds by simply pressing the send key after the system has opened the message in the messaging application. According to one further implementation, the message can be set to be sent automatically on given times.

These message type of contacts can be messaging-only contacts, such that a user only can send messages to the numbers associated with these kind of message, but not make calls. Hence, these messaging only type of contacts are not shown when user is looking for a contact to call. Message type of contacts can be categorized in groups or folders if needed.

In other words, message type of contacts can be added to contacts such that a user easily can find often-used messages via contacts. As a further advantage, message templates are retrieved from the same environments we are used to, such as a contact list.

1. A method for providing efficient handling of messages in a mobile communication terminal comprising associating at least one message template with at least one recipient, the message template comprising at least a first recipient identifier and at least a first sequence of predetermined symbols.

2. The method according to claim 1, wherein the association is performed upon a received user input.

3. The method according to claim 1, further comprising:
creating a message from the message template, and
transmitting the message to the recipient.

4. The method according to claim 1, wherein the association is performed in connection with sending a message to a recipient.

5. The method according to claim 4, wherein the association is performed automatically by the terminal.

6. The method according to claim 1, wherein at least a part of a message is stored as a message template in connection with sending the message.

7. The method according to claim 6, wherein at least an initial or ending section of the message is stored in the message template.

8. The method according to claim 1, wherein the recipient identifier identifies a service provider.

9. The method according to claim 1, wherein the sequence of predetermined symbols is associated with a service provided by a service provider.

10. The method according to claim 1, wherein the method further comprises removing an association between a contact and a message template.

11. The method according to claim 10, wherein the removing involves deleting the message template.

12. The method according to claim 10, wherein the removing is performed automatically by the terminal on associations where a message template has not been used within a predetermined period of time.

13. The method according to claim 10, wherein the removing is performed automatically by the terminal on associations on first-in-first-out basis, reclaiming memory storage for the most recently added message templates.

14. A method for retrieval of a message template from a group of candidate message templates comprising presenting a first candidate message template from the group of candidate message templates.

15. The method according to claim 14, wherein said group of candidate message templates are arranged in the form of a list.

16. The method according to claim 14, wherein said group of candidate message templates are associated with a recipient.

17. The method according to claim 14, wherein the retrieval involves activation of the group of candidate message templates.

18. The method according to claim 17, wherein said activation involves receiving a user input through pressing and holding an activation key.

19. The method according to claim 17, wherein the activation involves receiving a user input.

20. The method according to claim 19, wherein the user input is associated with selecting activation as one option from a list of options.

21. The method according to claim 17, wherein the activation involves selection of a recipient.

22. The method according to claim 17, wherein the activation involves matching of a pattern in a message with that of a candidate message template.

23. The method according to claim 22, wherein said matching is performed upon composing of a message.

24. The method according to claim 22, wherein the matching involves any of:
receiving a first sequence of symbols from the message;
identifying a corresponding sequence of symbols in at least a first candidate message template of the group of templates;
presenting the first candidate message template comprising the corresponding sequence of symbols;
receiving a user input for selection of the candidate message template;
and inserting the candidate message template into a message.

25. The method according to claim 22, wherein the pattern comprises letters and/or words.

26. The method according to claim 24, wherein the symbols comprises characters.

27. The method according to claim 17, wherein the activation comprises a combination of selection of a recipient and matching of a pattern in a message with that of a candidate message template.

28. The method according to claim 14, wherein the retrieval involves any of:
receiving a user input through a candidate scroll key for scrolling through the candidate message template;
receiving a user input through a candidate cycle key for scrolling through the group of candidate message templates;
presenting a second candidate message template from the group of templates;
receiving a user input through a candidate accept key for accepting the candidate message template; and
inserting the candidate message template into a message.

29. The method according to claim 28, wherein the candidate cycle key is any of the star ‘*’ or cross ‘#’ symbols, ‘up/down’ arrows, or ‘left/right’ arrows.

30. The method according to claim 28, wherein the candidate accept key is any of ‘space’, ‘right/space’, joystick middle, or a softkey.

31. The method according to claim 28, wherein the candidate scroll keys are any of the ‘up/down/left/right’, ‘left/right’, or ‘up/down’ keys.

32. The method according to claim 28, wherein the candidate cycle key is the star symbol ‘*’, the candidate accept key is ‘space’, and the keys for scrolling within template are ‘up/down/left/right’.

33. The method according to claim 28, wherein the candidate cycle keys are ‘up/down’, and the candidate accept key is ‘right/space’.

34. The method according to claim 28, wherein the candidate cycle key is ‘right’ and the candidate accept key is ‘up’.

35. The method according to claim 28, wherein the candidate cycle key is the zero ‘0’ key and the candidate accept is the OKAY ‘OK’ key.

36. The method according to claim 28, wherein the candidate cycle key is ‘#’ and the candidate scroll key is ‘space’.

37. The method according to claim 28, wherein the candidate cycle key is ‘*’ and the candidate accept key is ‘0’ and/or ‘space’.

38. The method according to claim 1, wherein the message template is any of an SMS, MMS, or e-mail.

39. The method according to claim 18, wherein the activation key is the star ‘*’ key.

40. The method according to claim 28, wherein said scrolling through candidate messages involves receiving a user input through a short pressing of said candidate cycle key.

41. A system comprising a server and a communication terminal, the server being arranged to provide the communication terminal with a message template associated with a recipient.

42. The system according to claim 41, wherein the message template is an interactive system message template for interpretation by the server in connection with requesting a service provided by a service provider.

43. The system according to claim 41, wherein the provision involves retrieval with the communication terminal of the message template from the server.

44. The system according to claim 43, wherein the retrieval involves a request from the communication terminal to the server.

45. The system according to claim 43, wherein the retrieval involves a query of a number of a service provided by a service provider.

46. A communication terminal adapted for providing efficient handling of messages, the terminal comprising means for associating at least one message template with at least one recipient, the message template comprising at least a first recipient identifier and at least a first sequence of predetermined symbols.

47. A computer program for performing a method according to claim 1.
